(19) United States
(12) Patent Application Publication
(10) Pub. No.: US 2024/0182010 A1
(43) Pub. Date: Jun. 6, 2024

(54) Retrofit Anti-lock Braking Tone Ring and Sensing System

(71) Applicant: DONALD PIERONEK, Lake Mills, WI (US)

(72) Inventor: DONALD PIERONEK, Lake Mills, WI (US)

(21) Appl. No.: 18/517,222

(22) Filed: Nov. 22, 2023

Related U.S. Application Data
(60) Provisional application No. 63/429,276, filed on Dec. 1, 2022.

(51) Int. Cl. B60T 8/58; G01P 3/481

(52) U.S. Cl. CPC B60T 8/58; G01P 3/481; B60T 2240/00

(57) ABSTRACT

A retrofit wheel speed sensing system for towed trailers including a retrofit tone ring retained at the inner grease seal location of a common in the art brake assembly and where said retrofit tone ring is monitored by a wheel speed sensor assembly mounted to said common in the art brake assembly where a wheel speed sensor is then connected to an Anti-lock Brake System (ABS) controller that modulates wheel speed during heavy braking. This invention thus retrofits existing common in the art trailer braking systems for ABS operation without replacing existing brake assemblies.

### RELATED APPLICATIONS

The present application claims priority to U.S. Provisional Application No. 63/429,276 filed on Dec. 1, 2022, the entire contents of which are incorporated herein by reference.

### TECHNICAL FIELD

The field of the present invention is a wheel speed sensing system composed of a retrofit tone ring and a sensing assembly used to retrofit existing towed trailers brake assemblies to control wheel speed, such as providing anti-lock braking when combined with a anti-lock brake system controller.

### BACKGROUND OF INVENTION

The trailer brakes are controlled by an electronic brake controller that sends electrical pulses to each brake magnet; the magnet then grips the brake drum, where the rotating brake drum forces the magnet housing against the brake shoe assembly thus actuating the brakes. The existing trailer brake controllers are difficult to calibrate properly to prevent locking up the tires under various road conditions and trailer speeds. Although Antilock Braking Systems (ABS) are common in the art in tow vehicles they are relatively new to towed trailer braking systems where a limited number of hydraulic disc brake and electric drum brake ABS systems currently exist. Like all other common in the art ABS systems, the existing trailer Antilock Braking Systems utilize tone ring (slots) machined into either the idler hub, brake drum or the brake rotor where wheel sensors monitor the passing metallic slots to determine wheel speed.

One problem with existing trailer ABS systems is that they minimally require replacement of the existing brake drums or rotors with a vendor specific complete brake drum assemblies containing the required tone ring slots. The tone ring slots are either located at the inner face of the brake drum near the brake magnet friction surface or utilize slots machined into the outer perimeter of the idler hub. Adoption of these trailer ABS systems has been slow due to these costly vendor specific components designed for a specific type of axle, the high cost of adding the required wheel speed monitoring sensors which requires replacement of the backing plate and other wheel braking components, and additional suspension components required to prevent excessive axle rotation and vibration during brake release by the ABS controllers.

### RELATED US PATENT DOCUMENTS

Provisional application No. 63/429,276 filed on Dec. 1, 2022
20060091723 May 10, 2018 Aaron Sinka
U.S. Pat. No. 11,629,765 Apr. 18, 2023 Scott Jenkinson
U.S. Pat. No. 11,633,981 Apr. 25, 2023 Padelis Katsaros
U.S. Pat. No. 11,773,937 Oct. 3, 2023 Colin Martin
2005/0035758 Feb. 17, 2005 Paul J. Waszkowski
2017/0261056 Sep. 14, 2017 Eric Bauer
2018/0290637 Oct. 11, 2018 Jay D. White
2018/0313417 Nov. 1, 2018 Jay D. White
2019/0120312 Apr. 25, 2019 Jay D. White
2021/0181228 Jun. 17, 2021 Daniel P. Zula SUMMARY OF INVENTION

This invention provides a wheel rotation sensing system by retrofitting existing non ABS trailer brake systems with a wheel speed retrofit tone ring without requiring replacing existing brake components such as brake drums, rotors, idler hubs, backing plates and other braking components with vendor specific ABS capable idler hubs, brake drums and/or brake rotors. This invention retrofits the existing rotating assembly with a retrofit tone ring, where said retrofit tone ring may take various forms, including but not limited to a separate tone ring installed with a common grease seal, a sealed tone ring that functions as both a tone ring and a grease seal, a sealed tone ring created by combining a tone ring and a grease seal, installed on the rotating assembly at the inner idler hub location. The retrofit tone ring is then monitored by a wheel speed sensor assembly mounted to the existing brake assembly, such as a backing plate mounting bolt or the spindle. The sensor provides signals to a connected anti-lock brake controller which uses wheel speed to modulate brakes thus retrofitting a common in the art brake assembly to provide anti-lock braking of existing towed trailers.

### BRIEF DESCRIPTION OF THE DRAWINGS

FIG. 1 is a drawing of one implementation of the wheel speed sensing system invention utilizing a combination tone ring body and grease seal material collectively referred to as a sealed tone ring (105) that is pressed into the idler hub (107) and a sensor assembly (111) that is attached to a backing plate (102) using an existing bolt (103) wherein a sensor monitors the rotation of said tone ring to determine the wheel speed.

FIG. 2 is a drawing by “Tie Down Engineering” showing component names of a typical towed trailer wheel hub rotating assembly less the brake drum.

FIG. 3 shows one implementation of the a sealed tone ring (301) where this inventions metallic tone ring body (302) contains sensor exciting elements using slots, similar to gear teeth, and a flexible grease seal material (303) is mated to said tone ring body.

FIG. 4 shows a wheel speed sensing system showing a wheel sensor mounting alternative of this invention utilizing a hose clamp (402) which retains the wheel sensor (401) to spindle (101).

FIG. 5 shows another implementation of invention of a sealed tone ring (505) where a metallic tone ring body (501) is slotted and contains grease sealing material (502) and where said sealed tone ring is inserted up to the machined face (503) of a idler hub (107).

FIG. 6 shows an implementation of invention wherein a slotted tone ring (602) is pressed into a Idler hub (107) after a standard grease seal (601) is installed into said idler hub.

FIG. 7 shows an implementation of invention of the sealed tone ring (704) wherein a common grease seal is modified to contain sensor exciting elements by removing material in the form of voids (702) from the metal portion (701) of said grease seal wherein the grease seal material (703) of said sealed tone ring prevents grease leakage through said voids or around the spindle.

FIG. 8 shows one implementation of invention wherein tone ring (801) contains slots, similar to gear teeth, on the outer perimeter of tone ring body wherein said tone ring is then retained in the idler hub after a grease seal (601).

FIG. 9 shows an implementation of inventions sensor assembly comprised of mounting hardware for a sensor (901) wherein said mounting hardware retaining said sensor in a sensor ring (902) that is installed over a spindle and held in place with one or more set screws (903).

FIG. 10 shows an implementation of wheel speed sensing system invention wherein a sensor assembly (1001) is slipped over the large inner diameter of a spindle (101) and held in place with one or more set screws wherein sensor (901) monitors the rotation of a sealed tone ring (105).

FIG. 11 shows an implementation of invention wherein a tone ring (1101) where tone ring body contains slots on its inner diameter and is inserted into the idler hub (107) after a grease seal (601) and held in place with one or more set screws (1103).

FIG. 12 shows one implementation of invention of a sealed tone ring (1203) composed of a metallic tone ring body (1201) containing slots that are attached to a common grease seal (1202).

FIG. 13 shows one detailed implementation of wheel speed sensing system invention where a sensor assembly (111) includes a sensor (1305) and mounting hardware which is affixed to backing plate (102) by replacing a existing nut (104) with said sensor assembly.

FIG. 14 shows a sealed tone ring (1203), from FIG. 12, installed in a brake drum (1401) where said brake drum is a single casting combining an idler hub (107) and a brake drum (113) into a single component.

FIG. 15 shows one implementation of wheel speed sensing system invention showing a sensor assembly (111) and a sealed tone ring (1203) shown in FIG. 13, installed on a backing plate (102) utilizing an existing backing plate bolt (103). For clarity a sensor assembly (111) is installed on a brake assembly, not showing a brake drum or idler hub which would hide the wheel speed sensing system, where a sealed tone ring (1203) is slipped over a spindle (101) at location where it would reside within said idler hub when a rotating assembly is installed.

### DETAILED DESCRIPTION

As required, detailed embodiments of the present invention are disclosed herein; however, it is to b understood that the disclosed embodiments are merely exemplary of the inventions that may be embodied by various alternative forms. The figures are not necessarily to scale; some features may be exaggerated or minimized to show details of particular components. Therefore, specific structural and functional details disclosed herein are not to be interpreted as limiting, but merely as representative base for teaching one skilled in the art to employ the present invention in various forms.

Implementations of this invention include but are not limited to those described herein where this invention provides the ability to retrofit an existing trailer braking system by adding this invention to monitor the rotation of a towed trailer wheel. The ability to monitor towed trailer wheel rotation can then be utilized to provide various functionality, including but not limited to adding anti-lock braking system (ABS) functionality to both new and existing towed trailers.

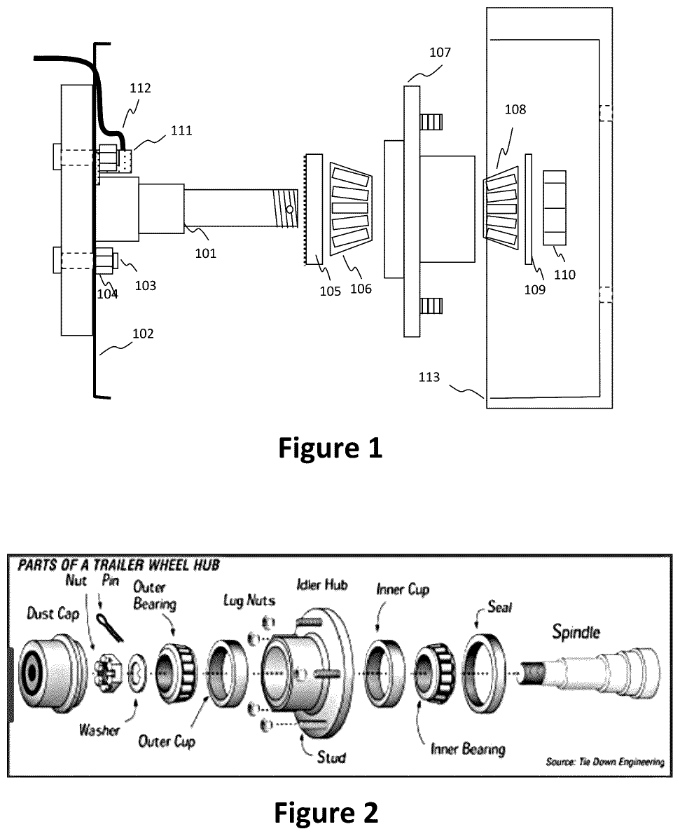

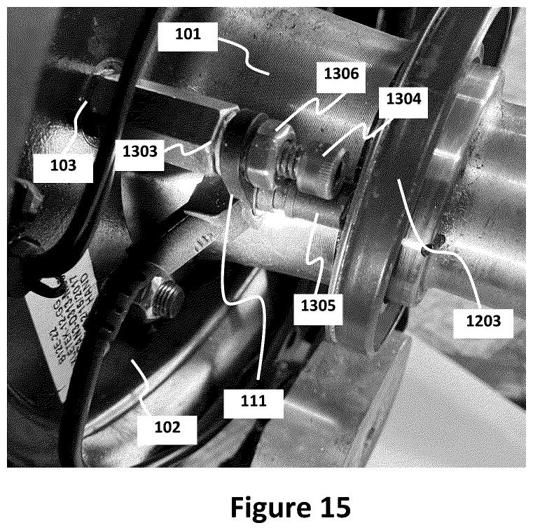

FIG. 1 is a drawing of one implementation of this invention which utilizes common in the art components shown in FIG. 2 with the following exceptions. In the preferred implementation the traditional seal, also referred to as a grease seal, is replaced with a sealed tone ring (105). A sensor assembly (111) comprising mounting hardware and a sensor (901) provides electronic signals to a brake controller, such as an anti-lock brake controller, via a sensor cable (112) where said sensor cable is part of said sensor assembly or depending on the sensor type used may be a separate component. The traditional wheel spindle (101) is usually bolted or welded to the axle housing where a brake backing plate (102) is then bolted to a spindle flange using multiple bolts (103) and lock nuts (104). The backing plate (102), mounting nuts (104) and bolts (103) all components mounted to a backing plate, including brake shoes, brake magnets and numerous other braking components not shown as they are not affected by this invention where when combined with the components shown in FIG. 2 are collectively referred to as a brake assembly. In the implementation of the invention in FIG. 1 a description of the retrofit installation follows. The wheel speed sensor assembly (111) is mounted to the backing plate (102) using one of the available spindle mounting nuts (104) and bolts (103). In one preferred implementation of invention shown in FIG. 15 a spindle mounting nut (104) is replaced with a sensor assembly. The tapered wheel bearing race (Inner Cup in FIG. 2) has already been pressed into the idler hub (107) during idler hub manufacture. The greased wheel bearing (106) is inserted into the Idler hub (107) and then this inventions sealed tone ring (105) is pressed into said idler hub holding the greased wheel bearing in place thus creating an idler hub assembly. The idler hub assembly is slid onto the spindle (101) and a greased outer bearing (108) is slid over said spindle and inserted into the idler hub assembly. The washer (109) is slid over the spindle (101) and then a nut (110) is threaded onto said spindle to hold the completed assembly in place and tightened per manufacturer specifications. A nut retainer (not shown in FIG. 1) and pin (shown in FIG. 2) are added to keep nut in place and lastly a dust cap (shown in FIG. 2) is installed. The brake drum (113) and wheel are then installed onto said idler hub studs and lug nuts (shown in FIG. 2) added and tightened to hold the entire brake drum/wheel assembly in place. Although it does not affect this invention, some manufacturers combine the idler hub (107) and the brake drum (113) into a single casting as shown in FIG. 14. For clarity FIG. 1 omitted various components of the brake assembly, such as the brake shoes, springs, levers, retainers, brake magnet and other braking components mounted to the backing plate (102) which are not altered by this invention. Unlike any existing trailer wheel speed sensing systems, this invention replaced a existing seal with a sealed tone ring (105) and replaced a backing plate nut (104) with a wheel speed sensor assembly (111) to provide wheel speed sensing on a common in the art brake assembly.

To clarity this invention one preferred implementation of a retrofit tone ring invention is where tone ring slots reside in the metal portion of a tone ring body of the inner grease seal creating a sealed tone ring. FIG. 12 shows another implementation of said sealed tone ring (1203) where a slotted tone ring body (1201) is attached to a commonly available grease seal (1202). As shown in FIG. 15 wheel speed monitoring is thus retrofitted to the majority of existing brake systems by merely replacing the existing inner seal with a sealed tone ring (1203) and mounting a wheel speed sensor assembly (111) to the backing plate (102) using an existing bolt (103). A retrofit tone ring approach may also be utilized on the rotors of disc brake systems as well utilizing various other versions of a sensor assembly. This invention thus adds wheel speed monitoring functionality to any existing trailer brake system, whether using electric brakes or hydraulic brakes.

The sensor assembly (111) in FIG. 1 contains a mechanical gap adjustment to set the distance between the sensor face and the rotating sealed tone ring (105). The sensor assembly (111) contains a mechanical exciting element adjustment to position the sensor face along the plurality of exciting elements of a retrofit tone ring, where said mechanical exciting element adjustment axis is dependent upon the location of said exciting elements of said retrofit tone ring. The version of a retrofit tone ring (105, 301, 505, 602, 704, 801, 1203) having exciting elements on the same plane as the backing plate moves sensor face on the axis perpendicular to said spindle (101) axis, moving closer to and further from said spindle where the sensor face is typically aligned with the center of said exciting elements. A retrofit tone ring (801, 1101) having exciting elements parallel to the spindle (101) axis would provide an exciting element adjustment that moves sensor face parallel to said spindle (101) axis. The mounting hardware of the sensor assembly (111) of this invention is mounted to the brake assembly and the sensor gap adjustment and exciting element adjustment may be set utilizing various approaches to include but not limited to those described herein for the purpose of providing a reliable signal to an electronic brake controller. In the preferred implementation when changing the sensor gap adjustment the exciting element adjustment would not change and vice versa but this feature is not a requirement of this invention. These sensor adjustments are required for various reasons including but not limited to; a) the sensitivity of a sensor to generate a reliable signal where an electronic brake controller is provided a signal that accurately reflects the passing of exciting elements of a tone ring body where signal levels typically drop as the distance between said exciting elements of the said tone ring body and a sensor face increases, b) wheel bearing adjustment and wear can cause movement in all directions thus changing said signals where they eventually are not reliable, c) manufacturing tolerances of all components related to monitoring wheel speed may require different sensor face locations from one installation to another and d) sensor assembly mounting locations and techniques will vary across different brake assemblies. The location of a sensor face is sensor dependent, where the sensor face is the physical location where said sensor detects the exciting elements of a tone ring body, where said sensor generates the most reliable signal.

FIG. 2 shows the component names used in this invention. Specifically the “seal” shown in FIG. 2 is a traditional seal composed of a metallic stamped metal seal housing and a flexible seal material utilized to prevent grease from leaving the inner bearing at the spindle where the seal is generally pressed into the idler hub and maintains its location due to friction between the seal housing and the idler hub where the seal is commonly referred to as a grease seal. This invention either places a tone ring in the idler hub next to the seal or combines the functionality provided by a common in the art seal providing the functionality of a traditional tone ring by replacing said seal with a combined seal and tone ring called a sealed tone ring. For clarity, although FIG. 2 shows an idler hub of a rotating assembly where a brake drum (not shown) is inserted over the studs of the idler hub and held in place by the lug nuts, some rotating assemblies combine the brake drum and the idler hub into single component, collectively referred to as an idler hub in this invention. Either configuration is compatible with this invention.

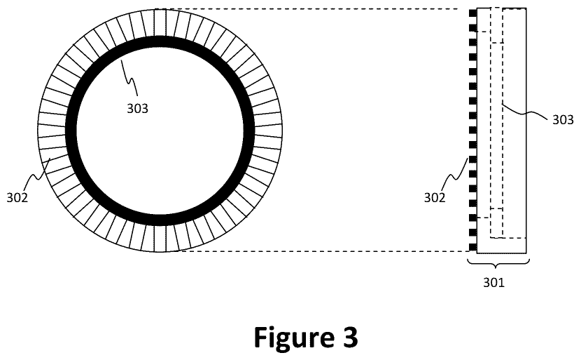

FIG. 3 shows one implementation of the sealed tone ring (301) version of a retrofit tone ring where a metal tone ring body (302) contains raised slots and where flexible seal material (303) is mated to said tone ring body during said sealed tone ring manufacture. Although this sealed tone ring description references a metallic tone ring body and thus utilizes a sensor capable of detecting passage of exciting elements of said tone ring body where this invention can utilize other materials for said tone ring and other types of sensors capable of detecting the movement of said tone ring.

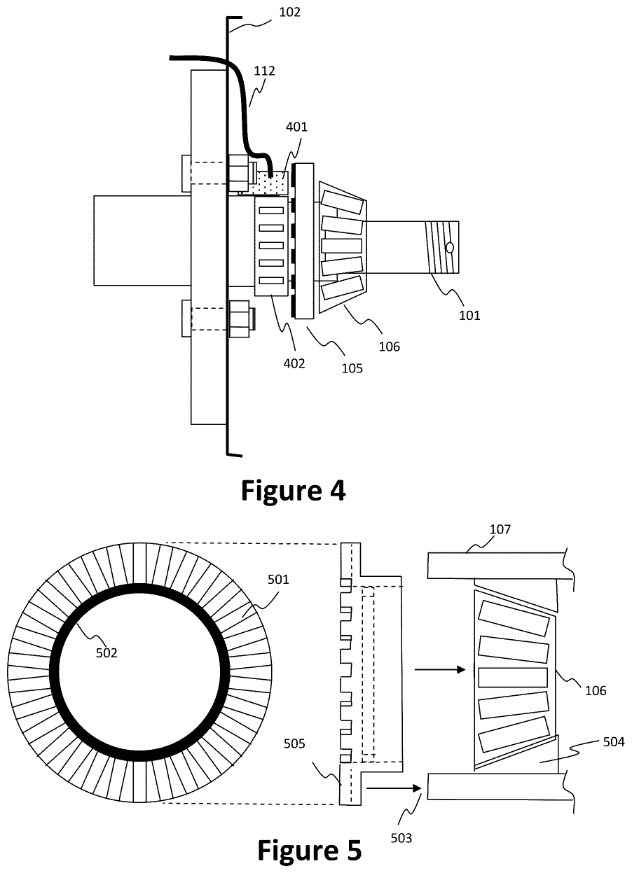

FIG. 4 indicates another sensor (401) mounting alternative utilizing a simple hose clamp (402) which retains a sensor bracket and thus enables one sensor mounting and gap adjustment approach for multiple spindle (101) sizes from multiple brake system manufacturers. Mounting a sensor assembly (401) to a spindle can be achieved in various ways versus using a hose clamp or versus mounting a sensor assembly to a backing plate (102).

FIG. 5 indicates another sealed tone ring (505) implementation of a retrofit tone ring where the metal tone ring body (501) is slotted and contains a flexible sealing material (502) creating said sealed tone ring component where said metal tone ring body is pressed into a idler hub (107) wherein insertion distance is limited when said tone ring body contacts said idler hub face (503) or contacts the bearing race (504) wherein insertion is limited by the shape of said tone ring body. In this implementation the outer tone ring body diameter exceeds the diameter of the traditional seal. Although this figure indicates slots on face of the metal tone ring body (501) the slots could also reside in the outer or inner perimeter of said tone ring body perpendicular to the spindle (801) similar to gear teeth. This invention includes and is not limited to where or how the exciting elements suitable of interacting with a sensor of various types are created on a tone ring body installed at the inner end of a rotating assembly hub. The inner end mounting location, whether within the interior bore of the idler hub or external to the idler hub at the inner end located towards the backing plate, are referred to as the grease seal location within this invention, where said rotating assembly is referred to as an idler hub even when it is a combined idler hub and brake drum or a combined idler hub and brake rotor.

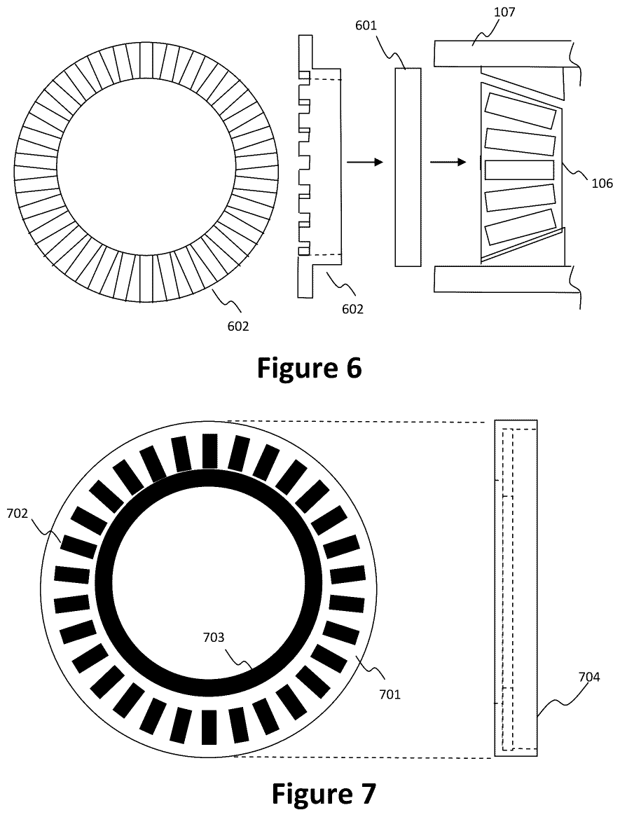

FIG. 6 shows another implementation of this invention where rather than creating a sealed tone ring component a slotted tone ring body (602) is pressed into the Idler hub (107) along with a standard grease seal (601) wherein said slotted tone ring may, or may not, be physically attached to said grease seal by various attaching means. When the tone ring body (602) is separate from the grease seal (601) said grease seal can be made solely of flexible sealing material and then retained by said tone ring body and not utilize a traditional grease seal made of metal and flexible sealing material. The diameter of the grease seal (601) can be smaller than the original grease seal it is replacing, where the smaller diameter seal is combined with a tone ring body, such as pressing a smaller diameter grease seal into said tone ring body or pressing said tone ring body into a grease seal, and then this sealed tone ring assembly installed in a idler hub.

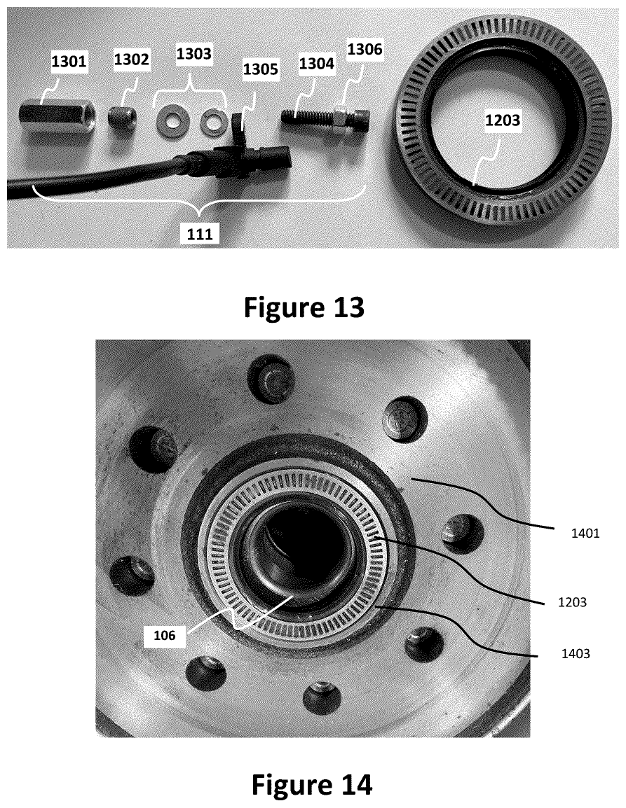

FIG. 7 shows one preferred implementation of this invention, similar to FIG. 12, wherein rather than installing a standard inner grease seal, the existing grease seal is replaced with a tone ring body (701) containing voids (702), where the metal portion of a standard seal has been removed and flexible sealing material (703) seals said voids and thus prevents grease leakage through said voids or around the spindle. The voids (702) of the tone ring body (701) are sensed by a sensor assembly (111 in FIG. 1, 401 in FIG. 4, 901 in FIG. 9. 1305 in FIG. 13) as said voids rotate past the face of a sensor. A tone ring (602, 801, 1101) or a sealed tone ring (105, 301, 505, 704, 1203) version of this invention are collectively referred to as a retrofit tone ring.

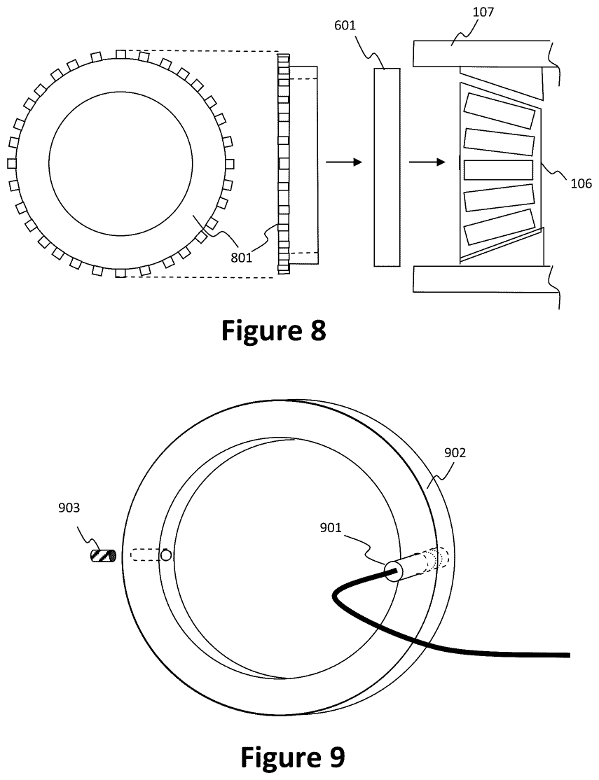

FIG. 8 shows one implementation of invention wherein a tone ring (801) contains slots, similar to gear teeth, on the outer perimeter of tone ring body where said tone ring is then pressed into the idler hub after a grease seal (601) is installed. This approach is preferred when the idler hub movement along the spindle axis relative to the sensor location is excessive which may result in excessive distance between said sensor and tone ring body and thus inaccurate wheel rotation measurements may occur. This excessive physical movement may be due to wheel bearing wear (106, 108), improper tightening of the retaining nut (110) and other mechanical issues. This invention includes a tone ring where a grease seal is installed into a tone ring body to create a sealed tone ring or where a tone ring body is installed in a grease seal.

FIG. 9 shows another version of a sensor assembly composed of a sensor (901), sensor ring (902) and set screw(s) (903). This implementation includes a sensor (901) that is retained in a sensor ring (902) that is slipped over a spindle (101) and held in place via a mechanical means, such as using one or more set screws (903). The inner diameter of a sensor ring (902) allows said sensor ring to slide over a spindle (101) to the desired location prior to the installation of a idler hub (107). A threaded hole in sensor ring into which a tubular shaped male threaded sensor is screwed where said threaded sensor is rotated to adjust the distance between the sensor face and the retrofit tone ring. Another sensor assembly alternative of invention could utilize a split ring where two halves of the split sensors ring are clamped together with clamping screws applying pressure to the spindle as said screws are tightened where the distance between the sensor face and the retrofit tone ring may also be adjusted by moving said sensor ring.

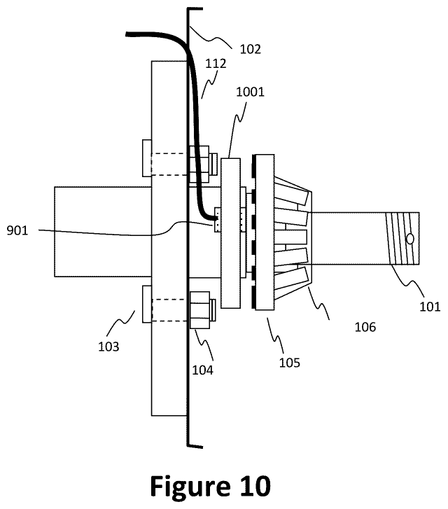

FIG. 10 shows how a sensor ring assembly (1001) is slipped over a spindle (101) between a backing plate (102) and a sealed tone ring (105) and held in place with the sensor ring screw(s). Thus the rotation of the retrofit tone ring (105) is detected by a sensor (901) where the distance between the retrofit tone ring (105) and the face of said sensor may be adjusted by moving said sensor ring (902) towards or away from said retrofit tone ring and then tightening sensor ring screw(s). Despite the clamping method used by a sensor ring (902) said sensor ring assembly may take multiple forms and may be composed of multiple parts.

Although not shown in a figure a sensor (901) may also be mounted in a recess within a spindle versus utilizing a mechanical mounting bracket. However this approach would require a custom spindle and thus is not a simple retrofit.

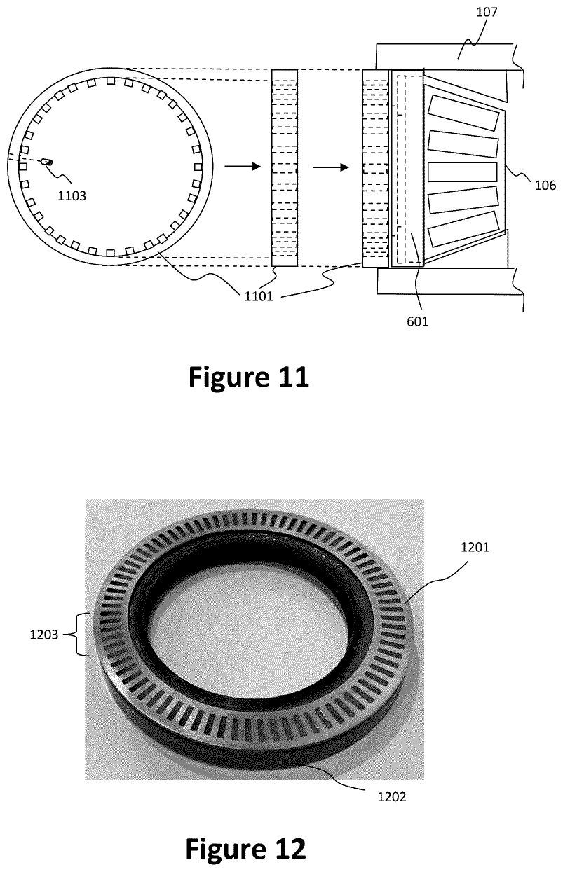

FIG. 11 shows another preferred implementation of a tone ring (1101) where a tone ring body has slots on its inner diameter similar to an internal tooth gear where said tone ring is either pressed into a wheel hub (107) or held in place by other mechanical means, to include but not be limited to one or more set screws (1103). A standard grease seal (601) is pressed into the wheel hub (107) prior to installing the tone ring (1101). Numerous sensor mounting techniques may use a sensor ring (902) attached to a spindle wherein the inner tooth tone ring (1101) is aligned with the outer diameter of said sensor ring (902) and thus the slots are aligned with a sensor (901).

FIG. 12 shows a sealed tone ring (1203) where a slotted tone ring body (1201) is mated to a common grease seal (1202) with a high temperature epoxy, where said slotted tone ring body is a larger diameter than said grease seal which when installed in a idler hub (107) or combined brake drum & idler hub (1401) locates said slotted tone ring body flush with the machined face (503, 1403) of said idler hub. Locating a sealed tone ring against the machined inner surface (503, 1403) of a idler hub will maintain a constant distance between a sensor face and a sealed tone ring (1203) as the idler hub rotates.

FIG. 13 shows one implementation of a sensor assembly (111) wherein mounting hardware of said sensor assembly is affixed to a backing plate (102) by replacing a existing nut (104) with said sensor assembly. Sensor assembly (111) mounting hardware includes but is not limited to the implementation shown in FIG. 13 where a coupling nut (1301) replaces a existing nut (104), then a threaded insert (1302) provides a transition from the threads of a backing plate stud (103) to those of a sensor retention screw (1304) where the distance between a sealed tone ring (1203) and sensor (1305) is adjusted using shim washers (1303) of varying thicknesses and the alignment of the sensor with the center of the exciting elements of said sealed tone ring are performed by rotating sensor and then tightening the nut (1306) to maintain said sensor position. The sensor cable is routed through an existing hole in backing plate (102) of brake assembly.

FIG. 14 shows a sealed tone ring (1403) installed into a combined brake drum & idler hub component (1401) where said sealed tone ring is pressed into said idler hub until tone ring body (1201) touches the idler hub face (1403) where said sealed tone ring retains the inner wheel bearing (106).

FIG. 15 shows one implementation of an installed wheel speed sensing system containing a sensor assembly (111) and a retrofit tone ring (1203) shown in FIG. 13. The sensor assembly (111) of FIG. 15 includes the sensor assembly mounting hardware installed on a existing bolt (103) of a baking plate (102) where the sensor gap adjustment of a sensor (1305) is adjusted using varying thicknesses of shims (1303) to set the desired distance between the sensor face and the sealed tone ring (1203) determined by the type of sensor and the type of exciting elements used on said sealed tone ring. Although not apparent in FIG. 15 the exciting element adjustment for the sensor (1305) is achieved by rotating the sensor around the retention screw (1304) axis where the nut (1306) is tighten when said sensor is aligned with the center of the exciting elements of the sealed retrofit tone ring (1203).

Although the various figures show rectangular slots on the tone ring bodies the exciting elements may take various forms and shapes, and where sensor detectable exciting elements may utilize various materials.

Although the invention describes tone ring bodies that utilize voids or slots in a metallic material wherein the passing of said slots or said voids are detected by a metal detecting sensor such as a hall effect sensor the invention may utilize sensors and exciting elements utilizing other materials and other detection techniques. Retrofitting a idler hub with a retrofit tone ring at the inner grease seal location to provide rotation detection is one novel approach of this invention.

Although the invention describes various methods of adjusting the distance between a sensor and a rotating retrofit tone ring the invention includes but is not limited to the adjustment examples described herein.

Although the invention describes various methods of attaching a retrofit tone ring to an idler hub and a sensor to a backing plate or a spindle the invention includes but is not limited to the examples described herein. For example, the retrofit tone ring could be attached to the outer perimeter of the idler hub casting where the method of attaching said retrofit tone ring to said idler hub at the grease seal location may require machining to existing common in the art idler hubs and as such, is not a preferred implementation of the invention. The sensor assembly of this invention may be mounted to a existing backing plate by modifying a backing plate to accept said sensor assembly but a preferred implementation of the invention utilize existing components for attachment.

Although tone ring body is used to describe a component containing sensor detectable elements that may take various forms said tone ring body may be comprised of multiple components to achieve the specified functionality of said tone ring body.

What is claimed:

1. An retrofit tone ring comprising;
a tone ring body containing a plurality of exciting elements suitable to be detected with a sensor;
said retrofit tone ring providing a means to be retained at the grease seal location of a idler hub;
said exciting elements of said tone ring body rotate with said idler hub.

2. A retrofit tone ring as in claim 1 further comprising;
a seal material bonded to said tone ring body;
said seal material preventing leakage of grease around or through said retrofit tone ring.

3. A retrofit tone ring as in claim 1 further comprising;
a grease seal;
said grease seal component is combined with said tone ring body;
said combined tone ring body and said grease seal providing a means to be retained at said grease seal location of said idler hub;
said exciting elements of said tone ring body rotate with said idler hub.

4. A retrofit tone ring as in claim 1 further comprising;
said tone ring body whose outer diameter is greater than the diameter of the hole in the idler hub into which a grease seal is installed;
the greater diameter of said tone ring body limiting insertion distance to the machined face of said idler hub thus maintaining a distance between the exciting elements of said tone ring body and a sensor as the idler hub rotates.

5. A retrofit tone ring as in claim 1 further comprising;
said retrofit tone ring installed at grease seal location of said idler hub;
a sensor capable of detecting passage of exciting elements of said tone ring;
sensor mounting hardware;
said sensor mounting hardware providing a means of retaining said sensor;
said sensor mounting hardware providing a means of attachment to a brake assembly;
said sensor mounting hardware attached to said brake assembly;
said idler hub installed on a spindle;
sensor face of said sensor aligned with said exciting elements of said retrofit tone ring thus modifying a common in the art towed trailer brake assembly to generate signals during the rotation of said idler hub creating a wheel speed sensing system.

6. A retrofit tone ring as in claim 2 further comprising;
said retrofit tone ring installed at grease seal location of said idler hub;
a sensor capable of detecting passage of exciting elements of said tone ring;
sensor mounting hardware;
said sensor mounting hardware providing a means of retaining said sensor;
said sensor mounting hardware providing a means of attachment to a brake assembly;
said sensor mounting hardware attached to said brake assembly;
said idler hub installed on a spindle;
the sensor face of said sensor aligned with said exciting elements of said retrofit tone ring thus modifying a common in the art towed trailer brake assembly to generate signals during the rotation of said idler hub creating a wheel speed sensing system.

7. A retrofit tone ring as in claim 3 further comprising;
said retrofit tone ring installed at grease seal location of said idler hub;
a sensor capable of detecting passage of exciting elements of said tone ring;
sensor mounting hardware;
said sensor mounting hardware providing a means of retaining said sensor;
said sensor mounting hardware providing a means of attachment to a brake assembly;
said sensor mounting hardware attached to said brake assembly;
said idler hub installed on a spindle;
the sensor face of said sensor aligned with said exciting elements of said retrofit tone ring thus modifying a common in the art towed trailer brake assembly to generate signals during the rotation of said idler hub creating a wheel speed sensing system.

8. A sensor assembly comprising;
a sensor capable of detecting passage of exciting elements of a retrofit tone ring;
sensor mounting hardware;
said sensor mounting hardware providing a means of retaining said sensor;
said sensor mounting hardware providing a means of attachment to a brake assembly;
said sensor monitoring the exciting elements of said retrofit tone ring installed at the grease seal location of a idler hub and thus said sensor monitoring the rotation of a retrofit tone ring.

9. A sensor assembly as in claim 8 further comprising;
having mechanical hardware providing a sensor gap adjustment to change the distance between said exciting elements of said retrofit tone ring and the sensor face of said sensor;
the location of said sensing face of said sensor adjusted closer to or further from said exciting elements of said retrofit tone ring to generate a reliable signal from said sensor.

10. A sensor assembly as in claim 8 further comprising;
having mechanical hardware providing a exciting element adjustment to change the location of the sensing face of said sensor across the face of said exciting elements of said retrofit tone ring body;
said sensing face of said sensor adjusted to provide a reliable signal from said exciting elements of said retrofit tone ring during variances in the physical movement of said exciting elements not in the rotational direction of the said idler hub.

11. A sensor assembly as in claim 8 further comprising;
a female threaded hardware component;
said threaded hardware component compatible with the diameter and threads of a backing plate mounting bolt;
where a mounting nut of said existing braking assembly is removed and said sensor assembly is mounted to said existing braking assembly without modification to said existing braking assembly.

12. The sensor assembly as in claim 8 further comprising;
mounting hardware having a female thread compatible with a backing plate bolt;
a mechanical means of attaching said sensor to said female threaded sensor mount;
a mechanical means of adjusting the distance between the sensor face and said retrofit tone ring;
and a mechanical means of adjusting the position of said sensor face along said exciting elements of said retrofit tone ring relative to said exciting element movement not in the rotational direction of said idler hub;
the rotation of said retrofit tone ring monitored by said sensor to retrofit a common in the art towed trailer brake assembly for purposes of monitoring wheel speed.

13. The sensor assembly as in claim 8 further comprising;
a mechanical means of attaching said sensor to a spindle;
a mechanical means of adjusting the distance between the sensor face and said retrofit tone ring;
and a mechanical means of adjusting the position of said sensor face along said exciting elements of said retrofit tone ring relative to said exciting element movement not in the rotational direction of said idler hub;
the rotation of said retrofit tone ring monitored by said sensor to retrofit a common in the art towed trailer brake assembly for purposes of monitoring wheel speed.

14. A wheel speed sensing system of claim 5 further comprising;
a plurality of said wheel speed sensing systems each installed on brake assembly;
each of said sensors generating signals connected via wires to a brake controller;
said brake controller determining each wheel speed from each of said signals;
said brake controller modulating braking signals to each wheel to vary said wheel speed.

15. A wheel speed sensing system of claim 6 further comprising;
a plurality of said wheel speed sensing systems each installed on brake assembly;
each of said sensors generating signals connected via wires to a brake controller;
said brake controller determining each wheel speed from each of said signals;
said brake controller modulating braking signals to each wheel to vary said wheel speed.

16. A wheel speed sensing system of claim 7 further comprising;
a plurality of said wheel speed sensing systems each installed on brake assembly;
each of said sensors generating signals connected via wires to a brake controller;
said brake controller determining each wheel speed from each of said signals;
said brake controller modulating braking signals to each wheel to vary said wheel speed.
